(19) United States
(12) Patent Application Publication
(10) Pub. No.: US 2020/0051133 A1
(43) Pub. Date: Feb. 13, 2020

(54) NETWORK USER IDENTIFICATION METHOD, DEVICE AND SERVER

(71) Applicant: BEIJING CREATIVE & INTERACTIVE DIGITAL TECHNOLOGY COMPANY LIMITED, Beijing (CN)

(72) Inventors: Dan HAN, Beijing (CN); Yan LIU, Beijing (CN); Hanbing LUO, Beijing (CN); Xiaoe BAI, Beijing (CN); Fangfang LU, Beijing (CN); Youjie CHEN, Beijing (CN); Bolin WANG, Beijing (CN); Weihai QU, Beijing (CN)

(21) Appl. No.: 16/518,233

(22) Filed: Jul. 22, 2019

(30) Foreign Application Priority Data
Aug. 8, 2018 (CN) 201810897155.8

(51) Int. Cl. G06Q 30/02; G06F 16/955

(52) U.S. Cl. CPC G06Q 30/0277; G06Q 30/0276; G06F 16/955

(57) ABSTRACT

The present application provides a network user identification method, device and a server. The identification method comprises: jumping from the front-end advertisement environment to a back-end web site environment when a user clicks an advertisement link under a front-end advertisement environment; acquiring a user identifier under the front-end advertisement environment and a user identifier under the back-end web site environment; and determining the identity information of the user based on the front-end user identifier and the back-end user identifier. By adopting the technical scheme, identification of the same user on the same device can be realized under a network environment.

### CROSS REFERENCE TO RELATED APPLICATION

The present application claims Paris Convention priority from Chinese patent application no. 201810897155.8 filed Aug. 8, 2018, contents of which are incorporated herein in their entirety.

### FIELD

The present application relates to the technical field of the Internet, in particular to a network user identification method, device and a server.

### BACKGROUND

The mainstream advertisement monitoring systems available in the market now identify the source of an advertisement user by adding a corresponding mark after the user clicks an advertisement display space to reach an advertisement landing page to realize the identification of source for network users. The method only classifies advertisement users through the source of advertisement links after clicking, but ignores the identification of advertisement users. For example, if the same advertisement user interacts with three different advertisement display spaces and reaches the same advertisement landing page in one day, the advertisement user will be identified as user A in the advertisement monitoring system (marked as 123e4567-e89b-12d3-a456-426655440000); however, in a website monitoring tool of the advertisement landing page, the user is marked as user B (marked as 1232137-u891-4389-q312-4832090000) with three different advertisement source marks.

At present, advertisement users can only be distinguished by the three different advertisement source marks in the website monitoring tool of the advertisement landing page, and the advertisement behavior of the same advertisement user cannot be associated with the web site behavior of the advertisement landing page by identifying the advertisement users. For example, a user logs on to the three websites, i.e. sohu, ifeng and sina, which contain JD's advertisements, on a computer separately, and after clicking the advertisements on the three websites, respectively, the user enters JD's website. Traditionally, JD's website cannot determine whether the front-end users are the same or not, but only knows that there are three accesses through advertisement links, so the effectiveness of advertisements cannot be evaluated, and it is even not understood that the three advertisement clicks originate from the same user or the same device. Therefore, there is a need for a network user identification method and device and a server to solve the above technical problems in the prior art.

### SUMMARY

In view of this, the present application provides a network user identification method, device and server to identity the same advertisement user on the same device.

According to one aspect of the present application, a network user identification method is provided, and the identification method comprises: jumping from a front-end advertisement environment to a back-end website environment when a user clicks an advertisement link under the front-end advertisement environment; acquiring a front-end user identifier under the front-end advertisement environment and a back-end user identifier under the back-end website environment; and determining the identity information of the user based on the front-end user identifier and the back-end user identifier through data interaction between the front-end advertisement environment and the back-end website environment.

Preferably, the step of acquiring a front-end user identifier under the front-end advertisement environment and a back-end user identifier under the back-end web site environment comprises: including, by an advertisement monitoring tool, an obtained user identifier in a third-party cookie under the front-end advertisement environment in the front-end user identifier under the front-end advertisement environment; and receiving, by the advertisement monitoring tool, the back-end user identifier sent by a web site monitoring tool, wherein the web site monitoring tool includes a user identifier in a first-party cookie under the back-end website environment in the back-end user identifier.

Preferably, the step of receiving, by the advertisement monitoring tool, the back-end user identifier sent by a website monitoring tool comprises: including, by the website monitoring tool, the obtained user identifier in the first-party cookie under the back-end website environment in the back-end user identifier under the back-end website environment; sending, by the website monitoring tool, the back-end user identifier to the advertisement monitoring tool in the form of a custom variable; and receiving and storing, by the advertisement monitoring tool, the custom variable to obtain the back-end user identifier.

Preferably, the step of acquiring a front-end user identifier under the front-end advertisement environment and a back-end user identifier under the back-end web site environment comprises: including, by a website monitoring tool, an obtained user identifier in a first-party cookie under the back-end website environment in the back-end user identifier under the back-end web site environment; and receiving, by the web site monitoring tool, the front-end user identifier sent by an advertisement monitoring tool, wherein the advertisement monitoring tool includes a user identifier in a third-party cookie in the front-end website environment in the front-end user identifier under the front-end advertisement environment.

Preferably, the step of receiving, by the web site monitoring tool, the front-end user identifier sent by an advertisement monitoring tool comprises: including, by the advertisement monitoring tool, the obtained user identifier in the third-party cookie under the front-end web site environment in the front-end user identifier under the front-end web site environment; sending, by the advertisement monitoring tool, the front-end user identifier to the website monitoring tool in the form of a custom variable; and receiving and storing, by the website monitoring tool, the custom variable to obtain the front-end user identifier.

Preferably, the step of acquiring a front-end user identifier under the front-end advertisement environment and a back-end user identifier under the back-end website environment comprises: including, by an advertisement monitoring tool, a received user device number or advertisement identifier of the mobile terminal sent by a media application program of a mobile terminal in the front-end user identifier; and/or, including, by a web site monitoring tool, a received user device number or advertisement identifier of the mobile terminal sent by a media application program of a mobile terminal in the back-end user identifier.

Preferably, the step of acquiring a front-end user identifier under the front-end advertisement environment and a back-end user identifier under the back-end web site environment comprises: obtaining, by a media application program, a user device number or advertisement identifier, and transmitting the user device number or advertisement identifier to a landing page monitoring tool in the form of a custom variable; adding, by the landing page monitoring tool, the custom variable behind an advertisement landing page address in underlying data to store the user device number or advertisement identifier; and after the front-end advertisement environment jumps to the back-end website environment, acquiring, by the advertisement monitoring tool, the custom variable to include the user device number or advertisement identifier in the front-end user identifier, and acquiring, by the website monitoring tool, the custom variable to include the user device number or advertisement identifier in the back-end user identifier.

Preferably, after acquiring the front-end user identifier under the front-end advertisement environment and the back-end user identifier under the back-end website environment, and before determining the identity information of the user based on the front-end user identifier and the back-end user identifier, the method further comprises: when the user is under the front-end advertisement environment, sending, by an advertisement monitoring tool, the front-end user identifier to a landing page monitoring tool in the form of a custom variable; adding, by the landing page monitoring tool, the custom variable behind an advertisement landing page address in underlying data to store the front-end user identifier; after the front-end advertisement environment jumps to the back-end website environment, sending, by a website monitoring tool, the back-end user identifier to the landing page monitoring tool in the form of a custom variable; and storing, by the landing page monitoring tool, the back-end user identifier in the custom variable.

Preferably, the front-end user identifier includes a user identifier in a third-party cookie under the front-end advertisement environment, and the back-end user identifier includes a user identifier in a first-party cookie under the back-end website environment.

Preferably, the advertisement link comprises a user identifier transmitted behind a landing page address by a media application program in the form of a custom variable; and the step of acquiring a front-end user identifier under the front-end advertisement environment and a back-end user identifier under the back-end website environment comprises: acquiring and storing, by an advertisement monitoring tool, the custom variable to acquire the front-end user identifier; and acquiring and storing, by a web site monitoring tool, the custom variable to acquire the back-end user identifier.

Preferably, the user identifier behind the landing page address comprises a user device number or advertisement identifier.

Preferably, the advertisement link comprises a user identifier transmitted after a landing page address by a media application program in the form of a custom variable; and the step of acquiring a front-end user identifier under the front-end advertisement environment and a back-end user identifier under the back-end website environment comprises: storing, by a landing page monitoring tool, the user identifier behind the advertisement landing page address in underlying data as the front-end user identifier; receiving and storing, by a website monitoring tool, the custom variable to obtain the back-end user identifier; sending, by the web site monitoring tool, the back-end user identifier to the landing page monitoring tool in the form of a custom variable; and adding, by the landing page monitoring tool, the custom variable behind the advertisement landing page address in the underlying data to store the back-end user identifier.

Preferably, the user identifier behind the landing page address comprises a user device number or advertisement identifier.

Preferably, the step of determining the identity information of the user based on the front-end user identifier and the back-end user identifier comprises: conducting, by the landing page monitoring tool, multi-identification on the user according to the front-end user identifier and the back-end user identifier, so as to determine the identity information of the user.

The present application further provides a network user identification device, and the identification device comprises: a jumping module, used for jumping from a front-end advertisement environment to a back-end website environment when a user clicks an advertisement link under a front-end advertisement environment; an identifier acquiring module, used for acquiring a front-end user identifier under the front-end advertisement environment and a back-end user identifier under the back-end web site environment; and an identity determining module, used for determining the identity information of the user based on the front-end user identifier and the back-end user identifier.

Preferably, the identifier acquiring module comprises: a front-end user identifier acquiring module, used for including, by an advertisement monitoring tool, an obtained user identifier in a third-party cookie under the front-end advertisement environment in the front-end user identifier under the front-end advertisement environment; and a back-end user identifier acquiring module, used for receiving, by the advertisement monitoring tool, the back-end user identifier sent by a website monitoring tool, wherein the website monitoring tool includes a user identifier in a first-party cookie under the back-end web site environment in the back-end user identifier.

Preferably, the back-end user identifier acquiring module is used for: including, by the website monitoring tool, the obtained user identifier in the first-party cookie under the back-end web site environment in the back-end user identifier under the back-end web site environment; sending, by the website monitoring tool, the back-end user identifier to the advertisement monitoring tool in the form of a custom variable; and receiving and storing, by the advertisement monitoring tool, the custom variable to obtain the back-end user identifier.

Preferably, the identifier acquiring module is used for: including, by a website monitoring tool, an obtained user identifier in a first-party cookie under the back-end web site environment in the back-end user identifier under the back-end web site environment; and receiving, by the web site monitoring tool, the front-end user identifier sent by an advertisement monitoring tool, wherein the advertisement monitoring tool includes a user identifier in a third-party cookie under the front-end web site environment in the front-end user identifier under the front-end advertisement environment.

Preferably, the identifier acquiring module is used for: including, by the advertisement monitoring tool, the obtained user identifier in the third-party cookie under the front-end web site environment in the front-end user identifier under the front-end web site environment; sending, by the advertisement monitoring tool, the front-end user identifier to the website monitoring tool in the form of a custom variable; and receiving and storing, by the website monitoring tool, the custom variable to obtain the front-end user identifier.

Preferably, the identifier acquiring module is further used for: including, by an advertisement monitoring tool, a received user device number or advertisement identifier of the mobile terminal sent by a media application program of a mobile terminal in the front-end user identifier; and/or, including, by a website monitoring tool, a received user device number or advertisement identifier of the mobile terminal sent by a media application program of a mobile terminal in the back-end user identifier.

Preferably, the identifier acquiring module is used for: obtaining, by a media application program, a user device number or advertisement identifier, and transmitting the user device number or advertisement identifier to a landing page monitoring tool in the form of a custom variable; adding, by the landing page monitoring tool, the custom variable behind an advertisement landing page address in underlying data to store the user device number or advertisement identifier; and after the front-end advertisement environment jumps to the back-end web site environment, acquiring, by the advertisement monitoring tool, the custom variable to include the user device number or advertisement identifier in the front-end user identifier, and acquiring, by the website monitoring tool, the custom variable to include the user device number or advertisement identifier in the back-end user identifier.

Preferably, the device further comprises an identifier concentration module, before the identity determining module, based on the front-end user identifier and the back-end user identifier after the front-end user identifier under the front-end advertisement environment and the back-end user identifier under the back-end website environment are acquired by the identifier acquiring module, determines the identity information of the user, used for: when the user is under the front-end advertisement environment, sending, by an advertisement monitoring tool, the front-end user identifier to a landing page monitoring tool in the form of a custom variable; adding, by the landing page monitoring tool, the custom variable behind an advertisement landing page address in underlying data to store the front-end user identifier; after the front-end advertisement environment jumps to the back-end website environment, sending, by a website monitoring tool, the back-end user identifier to the landing page monitoring tool in the form of a custom variable; and storing, by the landing page monitoring tool, the back-end user identifier in the custom variable.

Preferably, the front-end user identifier includes a user identifier in a third-party cookie under the front-end advertisement environment, and the back-end user identifier includes a user identifier in a first-party cookie under the back-end website environment.

Preferably, the advertisement link comprises a user identifier transmitted behind a landing page address by a media application program in the form of a custom variable; and the identifier acquiring module is used for: acquiring and storing, by an advertisement monitoring tool, the custom variable to acquire the front-end user identifier; and acquiring and storing, by a web site monitoring tool, the custom variable to acquire the back-end user identifier.

Preferably, the user identifier behind the landing page address comprises a user device number or advertisement identifier.

Preferably, the advertisement link comprises a user identifier transmitted behind a landing page address by a media application program in the form of a custom variable; the identifier acquiring module is used for: storing, by a landing page monitoring tool, the user identifier behind the advertisement landing page address in underlying data as the front-end user identifier; receiving and storing, by a website monitoring tool, the custom variable to obtain the back-end user identifier; sending, by the website monitoring tool, the back-end user identifier to the landing page monitoring tool in the form of a custom variable; and adding, by the landing page monitoring tool, the custom variable behind the advertisement landing page address in the underlying data to store the back-end user identifier.

Preferably, the user identifier behind the landing page address comprises a user device number or advertisement identifier.

Preferably, the identity determining module is used for: conducting, by the landing page monitoring tool, multi-identification on the user according to the front-end user identifier and the back-end user identifier, so as to determine the identity information of the user.

The present application further provides a network user identification device, and the identification device comprises: an advertisement monitoring tool, used for acquiring a front-end user identifier under a front-end advertisement environment; and a web site monitoring tool, used for acquiring a back-end user identifier under a back-end web site environment; wherein the advertisement monitoring tool, the website monitoring tool, or a third-party tool is further used for determining the identity information of the user based on the front-end user identifier and the back-end user identifier.

Preferably, the advertisement monitoring tool is further used for including an obtained user identifier in a third-party cookie under the front-end advertisement environment in the front-end user identifier under the front-end advertisement environment; and the website monitoring tool is further used for receiving the back-end user identifier sent by the website monitoring tool, wherein the website monitoring tool is further used for including a user identifier in a first-party cookie under the back-end web site environment in the back-end user identifier.

Preferably, the website monitoring tool is further used for including an obtained user identifier in a first-party cookie under the back-end web site environment in the back-end user identifier under the back-end web site environment, and sending the back-end user identifier to the advertisement monitoring tool in the form of a custom variable; and the advertisement monitoring tool is further used for receiving and storing the custom variable to obtain the back-end user identifier.

Preferably, the advertisement monitoring tool is further used for including an obtained user identifier in a third-party cookie under the front-end website environment in the front-end user identifier under the front-end advertisement environment; and the web site monitoring tool is further used for including an obtained user identifier in a first-party cookie under the back-end website environment in the back-end user identifier under the back-end website environment, and receiving the front-end user identifier sent by the advertisement monitoring tool.

Preferably, the advertisement monitoring tool is further used for including an obtained user identifier in a third-party cookie under the front-end website environment in the front-end user identifier under the front-end website environment, and sending the front-end user identifier to the website monitoring tool in the form of a custom variable; and the website monitoring tool is further used for receiving and storing the custom variable to obtain the front-end user identifier.

Preferably, the advertisement monitoring tool is further used for including a received user device number or advertisement identifier of the mobile terminal sent by a media application program of a mobile terminal in the front-end user identifier; and/or, the website monitoring tool is further used for including a received user device number or advertisement identifier of the mobile terminal sent by a media application program of a mobile terminal in the back-end user identifier.

Preferably, the advertisement monitoring tool is further used for acquiring and storing a user device number or advertisement identifier sent by a media application program in the form of a custom variable, so as to include the front-end user identifier; and the website monitoring tool is further used for acquiring and storing a user device number or advertisement identifier sent by a media application program in the form of a custom variable, so as to include the back-end user identifier.

Preferably, the third-party tool comprises a landing page monitoring tool; the advertisement monitoring tool is further used for sending the front-end user identifier to the landing page monitoring tool in the form of a custom variable when the user is under the front-end advertisement environment; the landing page monitoring tool is used for adding the custom variable behind an advertisement landing page address in underlying data to store the front-end user identifier; the website monitoring tool is further used for sending the back-end user identifier to the landing page monitoring tool in the form of a custom variable after the front-end advertisement environment jumps to the back-end website environment; and the landing page monitoring tool is further used for storing the back-end user identifier in the custom variable.

Preferably, the front-end user identifier includes a user identifier in a third-party cookie under the front-end advertisement environment, and the back-end user identifier includes a user identifier in a first-party cookie under the back-end website environment.

Preferably, the advertisement monitoring tool is further used for acquiring and storing a custom variable to acquire the front-end user identifier; and the website monitoring tool is further used for acquiring and storing a custom variable to acquire the back-end user identifier; wherein the custom variable comprises a user identifier transmitted behind a landing page address by a media application program in the form of a custom variable.

Preferably, the user identifier behind the landing page address comprises a user device number or advertisement identifier.

Preferably, the device further comprises a landing page monitoring tool, the landing page monitoring tool is used for storing a user identifier behind an advertisement landing page address in underlying data as the front-end user identifier; the website monitoring tool is further used for acquiring and storing a custom variable to acquire the back-end user identifier; the website monitoring tool is further used for sending the back-end user identifier to the landing page monitoring tool in the form of a custom variable; and the landing page monitoring tool is further used for adding the custom variable behind an advertisement landing page address in underlying data to store the back-end user identifier; wherein the custom variable stored in the website monitoring tool comprises a user identifier transmitted behind a landing page address by a media application program in the form of a custom variable.

Preferably, the user identifier behind the landing page address comprises a user device number or advertisement identifier.

Preferably, the landing page monitoring tool is further used for conducting multi-identification on the user according to the front-end user identifier and the back-end user identifier, so as to determine the identity information of the user.

According to another aspect of the present application, a server is provided and comprises the identification device described above.

According to the technical scheme of the present application, identification of the same advertisement user on the same device can be realized, thus more accurate advertisement service can be provided for the advertisement user and requirements of the advertisement user can be met.

Other features and advantages of the present application will be described in detail in the following detailed description.

### BRIEF DESCRIPTION OF THE DRAWINGS

The accompanying drawings, which form a part of the present application, are used to provide a further understanding of the present application, and the illustrative embodiments of the present application and the description thereof are used to explain the present application. In the drawings:

FIGS. 1-6 are flowcharts of a user identification method according to a preferred embodiment of the present application;

FIGS. 7 and 8 are schematic diagrams of an identification device according to a preferred embodiment of the present application;

FIG. 9 is a work flowchart of an identification device according to a preferred embodiment;

FIG. 10 is a schematic diagram of an identification device according to another preferred embodiment of the present application; and

FIGS. 11-12 are schematic diagrams of a server provided by the present application.

### DETAILED DESCRIPTION OF THE EMBODIMENTS

It should be noted that the embodiments in the present application and the features in various embodiments can be combined with each other without conflicts.

It should be noted that the term “front-end” used in the present application refers to an advertisement environment or advertisement environment website containing an advertisement display space (advertisement link), and “back-end” refers to a destination website to which the advertisement is linked.

Hereinafter, the present application will be described in detail with reference to the drawings and embodiments.

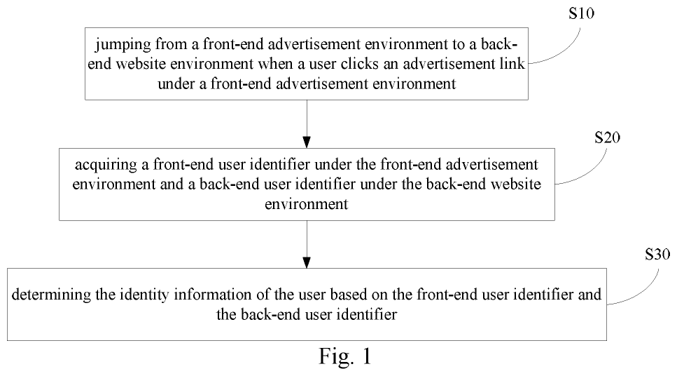

As shown in FIG. 1, a network user identification method provided in this embodiment comprises: S10, jumping from the front-end advertisement environment to a back-end website environment, namely a destination web site or destination landing page when a user clicks an advertisement link under a front-end advertisement environment; S20, acquiring a front-end user identifier under the front-end advertisement environment and a back-end user identifier under the back-end website environment; and S30, determining the identity information of the user based on the front-end user identifier and the back-end user identifier.

By adopting the method of the embodiment, the identifiers of the same advertisement user on the same device are related, and the identity information of the user is acquired after comprehensive judgment, thereby providing more accurate advertisement service for the user and meeting the requirements of the user.

By combining the front-end user identifier and the back-end user identifier to comprehensively determine the identity information of the user, the accurate identification of the source of the advertisement user and the accuracy of front-end advertisement environment identification are realized. For example, a user sees an advertisement of an e-business on a website A (the advertisement is put by the website A), and then clicks the advertisement link to log on to the shopping web site of the e-business; and by clicking an advertisement link of the e-business while visiting a website B on the same device, the user can also have access to the shopping website of the e-business. By adopting the identification method provided by the embodiment, the number of clicks of advertisement links can be counted on the back-end shopping website, besides, it can be identified that the two clicks are from the same device (i.e., the same user).

The network user identification method according to this embodiment is implemented mainly through data interaction between the front-end advertisement environment and the back-end website environment. For example, the above steps can be implemented by setting corresponding functional modules on a server corresponding to the back end, or by making corresponding improvements on the basis of existing functional modules of the server corresponding to the back end. For example, S20 and S30 can be completed by an advertisement monitoring tool and a web site monitoring tool, and the detailed implementation process is described below.

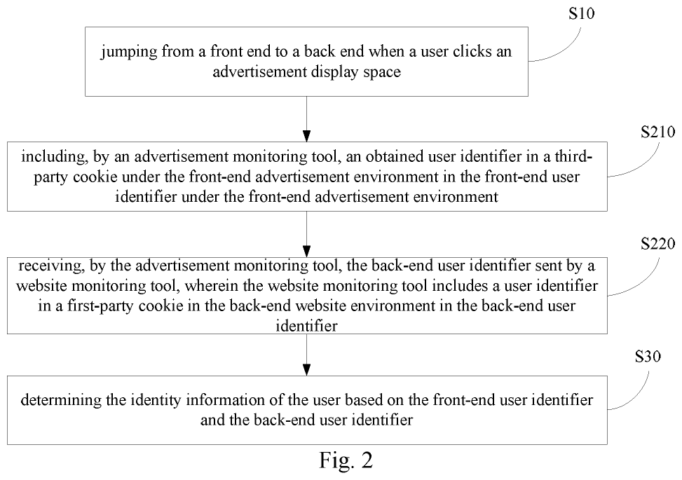

As shown in FIG. 2, preferably, S20 (acquiring a front-end user identifier under the front-end advertisement environment and a back-end user identifier under the back-end website environment) specifically comprises: S210, including, by an advertisement monitoring tool, an obtained user identifier in a third-party cookie under the front-end advertisement environment in the front-end user identifier under the front-end advertisement environment; and S220, receiving, by the advertisement monitoring tool, the back-end user identifier sent by a website monitoring tool, wherein the website monitoring tool includes a user identifier in a first-party cookie under the back-end website environment in the back-end user identifier.

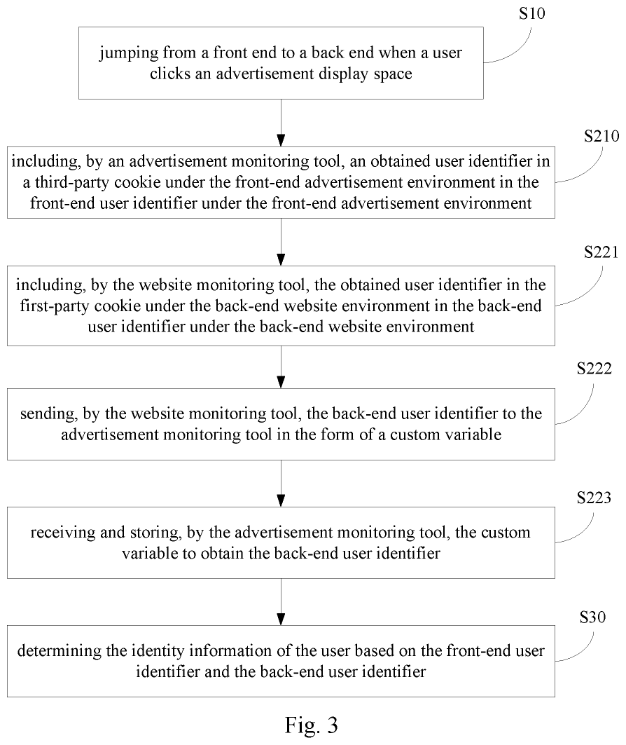

Further, as shown in FIG. 3, S220 (receiving, by the advertisement monitoring tool, the back-end user identifier sent by a website monitoring tool) specifically comprises: S221, including, by the website monitoring tool, the obtained user identifier in the first-party cookie under the back-end web site environment in the back-end user identifier under the back-end web site environment; S222, sending, by the web site monitoring tool, the back-end user identifier to the advertisement monitoring tool in the form of a custom variable; and S223, receiving and storing, by the advertisement monitoring tool, the custom variable to obtain the back-end user identifier.

The advertisement monitoring tool determines the identity information of the user based on the front-end user identifier and the back-end user identifier. It is easy to see that the front-end user identifier and the back-end user identifier can also be stored in the website monitoring tool, and the website monitoring tool determines the identity information of the user. For example, the website monitoring tool includes an obtained user identifier in a first-party cookie under the back-end website environment in the back-end user identifier under the back-end website environment; and the website monitoring tool receives the front-end user identifier sent by an advertisement monitoring tool, wherein the advertisement monitoring tool includes a user identifier in a third-party cookie in the front-end website environment in the front-end user identifier under the front-end advertisement environment. In a word, by the above-mentioned network user identification method, an advertisement user who is also a computer user accessing the network through the WEB can be accurately identified from the front end to the back end, and the user identifiers at the front end and the back end of the same advertisement user can be related. As described above, the identification method provided above allows the user identifier in the third-party cookie of the computer user to be related to the user identifier in the first-party cookie, thereby obtaining the identity information of the same advertisement user based on the user identifier in the third-party cookie and the user identifier in the first-party cookie.

Specifically, the advertisement monitoring tool sets a monitoring code in an advertisement material in the front-end advertisement environment, for example, adds a custom variable in an exposure code and a click code to obtain additional advertisement information, wherein the additional advertisement information includes the user identifier in the third-party cookie under the front-end advertisement environment. The advertisement monitoring tool modifies the codes to store the custom variable sent by the website monitoring tool (the advertisement monitoring tool stores the additional advertisement information obtained by itself).

Cookie can generally be divided into two types: first-party cookie and third-party cookie. Both the first-party cookie and the third-party cookie are small pieces of data stored by a website on a client. They are both stored in a certain domain and can only be accessed by this domain. The difference between them is not the difference in technology, but the usage mode. For example, if a website www.a.com sets a cookie and the cookie can only be read by the web pages under the domain of www.a.com, this is a first-party cookie. For the same website www.a.com, if a picture in a website www.b.com is used in the web page, when a browser requests the picture in www.b.com, www.b.com sets a cookie, then the cookie can only be accessed by the domain of www.b.com but not www.a.com, because for us, we are actually visiting the website www.a.com (front-end advertisement environment) where a cookie under the domain of www.b.com (back-end website environment) is set, so it is called a third-party cookie.

Traditionally, the front-end advertisement monitoring tool and the back-end website monitoring tool are two independent monitoring systems, which respectively monitor a front-end advertisement behavior and a back-end user behavior. The two monitoring systems both run on the server corresponding to the back end, and have different ways for identification of network users. The advertisement monitoring tool identifies the user through the user identifier in the third-party cookie, and the website monitoring tool identifies the user through the user identifier in the first-party cookie. The user identifiers in the two types of cookies are completely different marks, and it is usually impossible to relate the user identifiers in the two types of cookies that actually mark the same user, so the identity information of the advertisement user cannot be accurately identified.

In the method of this embodiment, the advertisement monitoring tool and the website monitoring tool store the user identifiers in the cookies in the form of custom variables respectively, and the website monitoring tool transmits the user identifier in the first-party cookie to the advertisement monitoring tool in the form of a custom variable, so that the advertisement monitoring tool not only retains the original user identifier in the third-party cookie, but also stores the user identifier in the first-party cookie sent by the web site monitoring tool, thus relating multiple identity information of the same user. In addition, the website monitoring tool receiving the front-end user identifier sent by the advertisement monitoring tool may further comprise: including, by the advertisement monitoring tool, the obtained user identifier in the third-party cookie under the front-end web site environment in the front-end user identifier under the front-end website environment; sending, by the advertisement monitoring tool, the front-end user identifier to the website monitoring tool in the form of a custom variable; and receiving and storing, by the website monitoring tool, the custom variable to obtain the front-end user identifier.

For example, the specific implementation process is as follows:

i. modifying a code of the website monitoring tool and a code of the advertisement monitoring tool, respectively, so that the user identifier obtained by the website monitoring tool is transmitted to the advertisement monitoring tool in the form of the custom variable U to finish preparation;

ii. when the user clicks the advertisement link, jumping from the front-end advertisement environment to the back-end website environment to reach an advertisement landing page;

iii. obtaining, by the website monitoring tool and the advertisement monitoring tool, the user identifiers, respectively, marking the user identifier in the advertisement monitoring tool as 123e4567-e89b-12d3-a456-426655440000, which is included in the front-end user identifier, and marking the user identifier in the website monitoring tool as 1232137-u891-4389-q312-4832090000, which is included in the back-end user identifier;

iv. transmitting, by the web site monitoring tool, the acquired user identifier 1232137-u891-4389-q312-4832090000 to the advertisement monitoring tool in the form of the custom variable U;

v. acquiring and storing, by the advertisement monitoring tool, the user identifier 1232137-u891-4389-q312-4832090000 transmitted by the website monitoring tool;

vi. acquiring, by the advertisement monitoring tool, both the user identifiers (1232137-u891-4389-q312-4832090000 and 123e4567-e89b-12d3-a456-426655440000), thus relating the front-end user identifier to the back-end user identifier, and;

vii. conducting, by the advertisement monitoring tool, double identification based on both the user identifiers to determine the identity information of the user.

In this embodiment, S20 can be completed by the advertisement monitoring tool and the website monitoring tool, and S30 can be completed by the advertisement monitoring tool, or can be completed by a third-party tool independent of the advertisement monitoring tool and the website monitoring tool (described below).

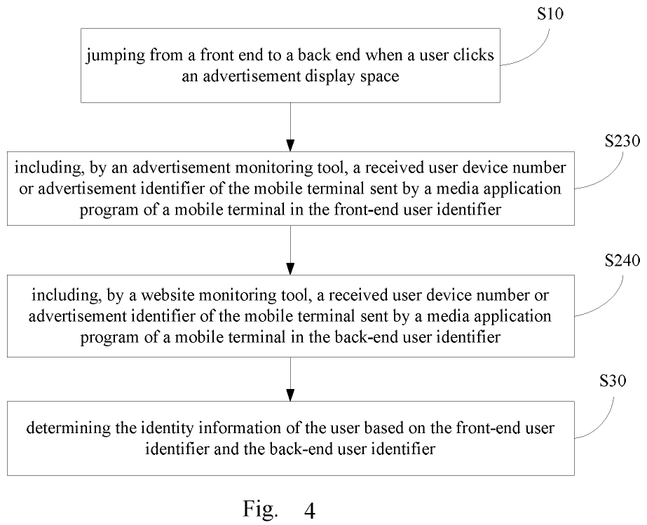

Preferably, as shown in FIG. 4, S20 (acquiring a front-end user identifier under the front-end advertisement environment and a back-end user identifier under the back-end website environment) may comprise: S230, including, by an advertisement monitoring tool, a received user device number or advertisement identifier of the mobile terminal sent by a media application program of a mobile terminal in the front-end user identifier; and/or, S240, including, by a website monitoring tool, a received user device number or advertisement identifier of the mobile terminal sent by a media application program of a mobile terminal in the back-end user identifier.

This embodiment can relate an advertisement identifier (IDFA, ADID) or user device number (MEI) of a user of a mobile terminal to a user identifier in a first-party cookie in an APP/WAP environment, and realize related identification of the identity information of the same user.

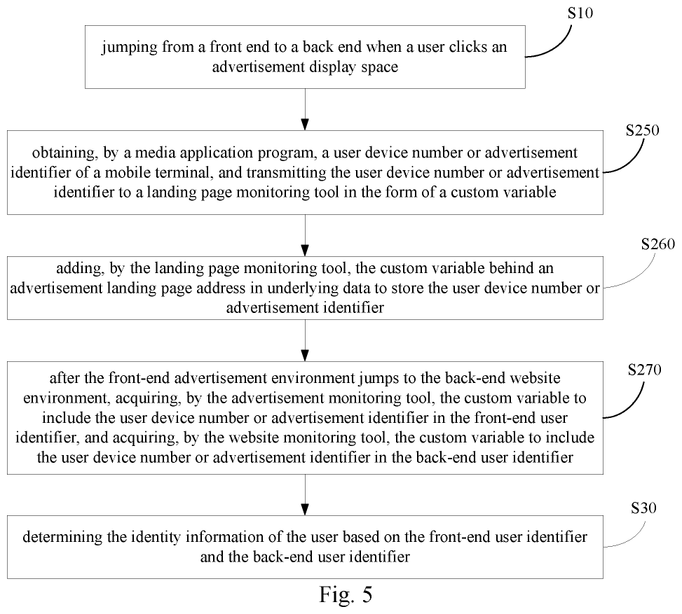

Therefore, as shown in FIG. 5, S20 (acquiring a front-end user identifier under the front-end advertisement environment and a back-end user identifier under the back-end website environment) may further comprise: S250, obtaining, by a media application program, a user device number or advertisement identifier of a mobile terminal, and transmitting the user device number or advertisement identifier to a landing page monitoring tool in the form of a custom variable; S260, adding, by the landing page monitoring tool, the custom variable behind an advertisement landing page address in underlying data to store the user device number or advertisement identifier; and S270, after the front-end advertisement environment jumps to the back-end web site environment, acquiring, by the advertisement monitoring tool, the custom variable to include the user device number or advertisement identifier in the front-end user identifier, and acquiring, by the website monitoring tool, the custom variable to include the user device number or advertisement identifier in the back-end user identifier.

IDFA is the shortened form of Identifier For Advertisement, which is a unique identifier related to a device and can be used to relate advertising behaviors between different apps. For example, when someone searches for a product W on a shopping website and then uses a browser to browse a web page, the advertisement of the product W will be displayed on the web page. IDFA is a hexadecimal 32-bit string.

ADID is an advertisement identifier provided in an Android system, and each device has only one unique ADID. The media application program can be an APP such as Bitauto and Autohome, as long as a device number (IMEI) or advertisement identifier (IDFA/ADID) of the mobile terminal of the user can be obtained.

For users interacting with advertisements in an APP environment, the device number (IMEI) or advertisement identifier (IDFA/ADID) of a mobile device used by a mobile terminal user is the unique identifier which can be used to identify the user, but neither the device number nor the advertisement identifier can be directly obtained through the advertisement monitoring tool and the website monitoring tool, so it is necessary to communicate with (e.g. media) application programs, so that the obtained user device number (IMEI) or advertisement identifier (IDFA/ADID) is transmitted behind a landing page address which appears after the user clicks the advertisement link in the form of the custom variable U (encryption is required for the privacy protection of the user and security considerations, and MD5 is preferred). By modifying and setting the advertisement monitoring tool and the web site monitoring tool correspondingly, the advertisement monitoring tool and the website monitoring tool can automatically capture the custom variable U transmitted by the media application program. In this way, both the advertisement monitoring tool and the website monitoring tool can obtain the device number or advertisement identifier, so that the front-end user identifier and the back-end user identifier can be related to through the advertisement monitoring tool and the website monitoring tool under the APP environment, and the front-end and back-end behavior data of the user can be related.

For example, the specific process is as follows:

i. modifying the code of the advertisement monitoring tool and the code in the website monitoring tool so that they can obtain the custom variable U transmitted by the media application program;

ii. acquiring, by the media application program, the device number (IMEI) or advertisement identifier (IDFA/ADID), and transmitting the same behind the landing page address in the form of the custom variable U (preferably encrypted before transmission), such as http://www.bitauto.com.cn?U=P1WnGvVR1W;

iii. clicking, by the user, the advertisement display space, so that the front end jumps to the back end to reach the landing page;

iv. acquiring, by the advertisement monitoring tool and the website monitoring tool, the device number (IMEI) or advertisement identifier (IDFA/ADID) transmitted by the media application program in the form of the custom variable U, so as to relate the front-end user identifier to the back-end user identifier; and

v. determining, by the advertisement monitoring tool or website monitoring tool, the identity information of the user according to the device number (IMEI) or advertisement identifier (IDFA/ADID).

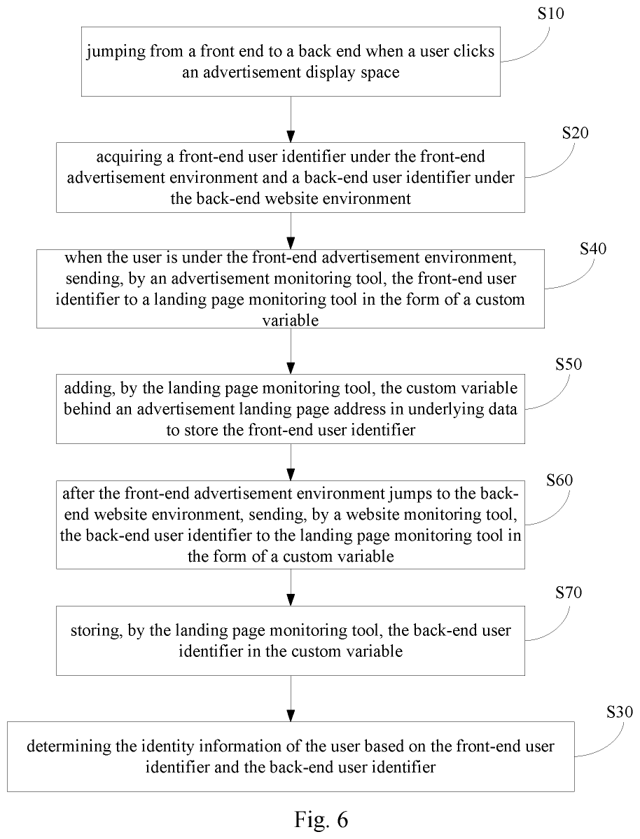

Preferably, as shown in FIG. 6, after S20 (acquiring a front-end user identifier under the front-end advertisement environment and a back-end user identifier under the back-end web site environment), and before S30 (determining the identity information of the user based on the front-end user identifier and the back-end user identifier), the network user identification method in this embodiment further comprises: S40, when the user is under the front-end advertisement environment, sending, by an advertisement monitoring tool, the front-end user identifier to a landing page monitoring tool in the form of a custom variable; S50, adding, by the landing page monitoring tool, the custom variable behind an advertisement landing page address in underlying data to store the front-end user identifier; S60, after the front-end advertisement environment jumps to the back-end website environment, sending, by a website monitoring tool, the back-end user identifier to the landing page monitoring tool in the form of a custom variable; and S70, storing, by the landing page monitoring tool, the back-end user identifier in the custom variable.

Preferably, S30 (determining the identity information of the user based on the front-end user identifier and the back-end user identifier) specifically comprises: conducting, by the landing page monitoring tool, multi-identification on the user according to the front-end user identifier and the back-end user identifier, so as to determine the identity information of the user.

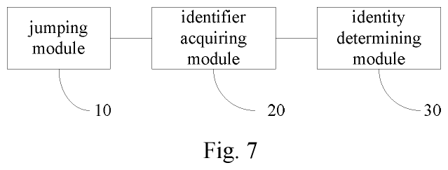

Preferably, as shown in FIG. 7, the network user identification device provided by the embodiment comprises: a jumping module 10, used for jumping from the front-end advertisement environment to a back-end website environment when a user clicks an advertisement link under a front-end advertisement environment; an identifier acquiring module 20, used for acquiring a front-end user identifier under the front-end advertisement environment and a back-end user identifier under the back-end web site environment; and an identity determining module 30, used for determining the identity information of the user based on the front-end user identifier and the back-end user identifier.

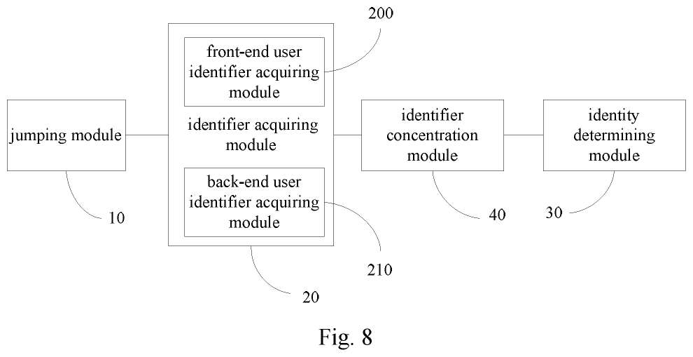

Preferably, as shown in FIG. 8, in the identification device according to the embodiment, the identifier acquiring module 20 comprises: a front-end user identifier acquiring module 200, used for including, by an advertisement monitoring tool, an obtained user identifier in a third-party cookie under the front-end advertisement environment in the front-end user identifier under the front-end advertisement environment; and a back-end user identifier acquiring module 210, used for receiving, by the advertisement monitoring tool, the back-end user identifier sent by a website monitoring tool, wherein the website monitoring tool includes a user identifier in a first-party cookie under the back-end web site environment in the back-end user identifier.

Preferably, the back-end user identifier acquiring module 210 is specifically used for: including, by the website monitoring tool, the obtained user identifier in the first-party cookie under the back-end web site environment in the back-end user identifier under the back-end web site environment; sending, by the web site monitoring tool, the back-end user identifier to the advertisement monitoring tool in the form of a custom variable; and receiving and storing, by the advertisement monitoring tool, the custom variable to obtain the back-end user identifier.

The identifier acquiring module 20 may also be used for: including, by the website monitoring tool, an obtained user identifier in a first-party cookie under the back-end web site environment in the back-end user identifier under the back-end web site environment; and receiving, by the web site monitoring tool, the front-end user identifier sent by an advertisement monitoring tool, wherein the advertisement monitoring tool includes a user identifier in a third-party cookie in the front-end website environment in the front-end user identifier under the front-end advertisement environment.

The identifier acquiring module 20 is used for: including, by the advertisement monitoring tool, the obtained user identifier in the third-party cookie under the front-end web site environment in the front-end user identifier under the front-end web site environment; sending, by the advertisement monitoring tool, the front-end user identifier to the website monitoring tool in the form of a custom variable; and receiving and storing, by the website monitoring tool, the custom variable to obtain the front-end user identifier.

The identification device of this embodiment can be realized by the advertisement monitoring tool and the website monitoring tool. Traditionally, the advertisement monitoring tool and the web site monitoring tool are two independent monitoring systems, and have different ways for marking the user identifiers of computer users (the advertisement monitoring tool identifies the user through the user identifier in the third-party cookie, and the website monitoring tool identifies the user through the user identifier in the first-party cookie). The user identifiers in the two types of cookies are completely different marks, but the user identifiers in the two different types of cookies mark the same user (same device).

The device provided in this embodiment may be set on a server corresponding to the back end, or may be a device separately installed in a network system. In this embodiment, the website monitoring tool transmits the user identifier in the first-party cookie of the website monitoring tool to the advertisement monitoring tool in the form of a custom variable, so that the advertisement monitoring tool not only retains the original user identifier in the third-party cookie, but also stores the user identifier in the first-party cookie sent by the web site monitoring tool, thus realizing the identification of multiple identities of the same user and determining the final identity information of the user. By adopting the identification device of the embodiment, for example, the user identifier of the computer user in the third-party cookie and the user identifier in the first-party cookie can be related.

As another preferred mode of this embodiment, the identifier acquiring module 20 is further specifically used for: including, by an advertisement monitoring tool, a received user device number or advertisement identifier of the mobile terminal sent by a media application program of a mobile terminal in the front-end user identifier; and/or, including, by a web site monitoring tool, a received user device number or advertisement identifier of the mobile terminal sent by a media application program of a mobile terminal in the back-end user identifier.

The identifier acquiring module 20 is used for: obtaining, by a media application program, a user device number or advertisement identifier, and transmitting the user device number or advertisement identifier to a landing page monitoring tool in the form of a custom variable; adding, by the landing page monitoring tool, the custom variable behind an advertisement landing page address in underlying data to store the user device number or advertisement identifier; and after the front-end advertisement environment jumps to the back-end web site environment, acquiring, by the advertisement monitoring tool, the custom variable to include the user device number or advertisement identifier in the front-end user identifier, and acquiring, by the website monitoring tool, the custom variable to include the user device number or advertisement identifier in the back-end user identifier.

The identification device of this embodiment can relate the user identifier in the third-party cookie to the user identifier in the first-party cookie from APP to WAP for the mobile terminal user: (1) adding, by the advertisement monitoring tool, a monitoring code to the exposure code and the click code in the advertisement material, and adding the custom variable U to the monitoring code, wherein the custom variable U includes IMEI, IDFA or ADID which is transmitted by the media application program; (2) adding a custom variable behind the landing page address in underlying data of the advertisement monitoring tool to be used for storing IMEI, IDFA or ADID transmitted from the medium application program, wherein the value of this custom variable will appear in the underlying data acquired by the third-party monitoring code; and as the third-party monitoring code and the first-party monitoring code are added to the landing page at the same time and the custom variable U is set in the third-party monitoring code, the custom variable U is used to transmit the value of the user identifier in the first-party cookie when the first-party monitoring code is loaded. In other words, the underlying data of the third-party monitoring code includes both the value of the user identifier in the third-party cookie and the value transmitted by the custom variable U, that is, the value of the user identifier in the first-party cookie.

According to a preferred mode of this embodiment, as shown in FIG. 8, the device further comprises an identifier concentration module 40, wherein after the identifier acquiring module acquires a front-end user identifier under the front-end advertisement environment and a back-end user identifier under the back-end web site environment, and before the identity determining module 30, based on the front-end user identifier and the back-end user identifier, determines the identity information of the user, the identifier concentration module 40 is used for: when the user is under the front-end advertisement environment, sending, by an advertisement monitoring tool, the front-end user identifier to a landing page monitoring tool in the form of a custom variable; adding, by the landing page monitoring tool, the custom variable behind an advertisement landing page address in underlying data to store the front-end user identifier; after the front-end advertisement environment jumps to the back-end website environment, sending, by a website monitoring tool, the back-end user identifier to the landing page monitoring tool in the form of a custom variable; and storing, by the landing page monitoring tool, the back-end user identifier in the custom variable.

Further, the identity determining module 30 is specifically used for: conducting, by the landing page monitoring tool, multi-identification on the user according to the front-end user identifier and the back-end user identifier, so as to determine the identity information of the user.

The advertisement landing page monitoring tool not only needs to add a first-party monitoring code (collect the user identifier in the first-party cookie) but also needs to add a third-party monitoring code (collect the user identifier in the third-party cookie). The advertisement monitoring tool sets a custom variable in the third-party monitoring code, which is used to transmit the value of the user identifier in the third-party cookie triggered when the third-party monitoring code is loaded.

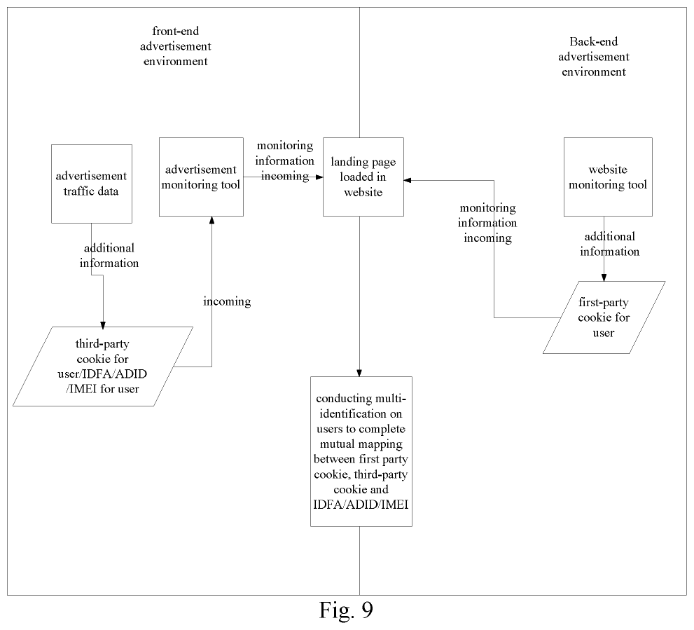

For example, the relating workflow is shown in FIG. 9:

Step 1, adding, by the advertisement monitoring tool using technical means, the front-end user identifiers, such as IDFA, ADID, IMEI, or the user identifier in the third-party cookie;

Step 2, loading, by the advertisement monitoring tool, the front-end user identifier to the advertisement landing page monitoring tool on a website side;

Step 3, after the front-end advertisement environment jumps to the back-end website environment to reach the landing page, triggering the website monitoring tool, and using technical means to obtain the back-end user identifiers, such as IDFA, ADID, IMEI, or the user identifier in the first-party cookie;

Step 4, transmitting the acquired back-end user identifier to the advertisement landing page monitoring tool at the website side; and

Step 5, conducting multi-identification on the user in the advertisement landing page monitoring tool at the website side to determine the identity information of the user, so as to relate full-link data of a single user on the same device.

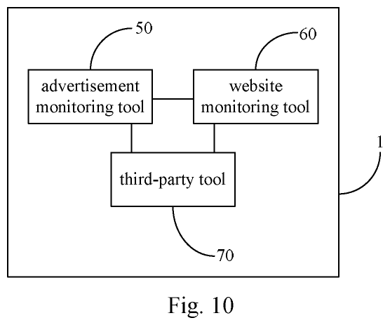

As shown in FIG. 10, a network user identification device provided by the embodiment comprises: an advertisement monitoring tool 50, used for acquiring a front-end user identifier under a front-end advertisement environment; and a website monitoring tool 60, used for acquiring a back-end user identifier under a back-end website environment; wherein the advertisement monitoring tool 50, the website monitoring tool 60, or a third-party tool is further used for determining the identity information of the user based on the front-end user identifier and the back-end user identifier. The network user identification device provided by the embodiment can be implemented by making some improvements on the advertisement monitoring tool 50, the website monitoring tool 60 and/or the third-party tool on the server corresponding to the back end, and can be implemented by respectively modifying the codes of the advertisement monitoring tool 50, the website monitoring tool 60 and/or the third-party tool to realize their corresponding functions.

Preferably, the advertisement monitoring tool 50 is further used for including an obtained user identifier in a third-party cookie under the front-end advertisement environment in the front-end user identifier under the front-end advertisement environment; and the advertisement monitoring tool 50 is further used for receiving the back-end user identifier sent by the website monitoring tool 60, wherein the website monitoring tool 60 is further used for including a user identifier in a first-party cookie under the back-end web site environment in the back-end user identifier. An advertisement user who is also a computer user accessing the network through the WEB can be accurately identified from the front end to the back end, and the user identifiers at the front end and the back end of the same advertisement user can be related.

Further, the website monitoring tool 60 is further used for: including an obtained user identifier in a first-party cookie under the back-end web site environment in the back-end user identifier under the back-end web site environment, and sending the back-end user identifier to the advertisement monitoring tool in the form of a custom variable; and the advertisement monitoring tool 50 is further used for receiving and storing the custom variable to obtain the back-end user identifier. The user identifier in the third-party cookie of the computer user is related to the user identifier in the first-party cookie, thereby obtaining the identity information of the same advertisement user based on the user identifier in the third-party cookie and the user identifier in the first-party cookie.

Similarly, the advertisement monitoring tool 50 is further used for including a user identifier in a third-party cookie under the front-end website environment in the front-end user identifier under the front-end advertisement environment; and the website monitoring tool 60 is further used for including an obtained user identifier in a first-party cookie under the back-end website environment in the back-end user identifier under the back-end website environment, and receiving the front-end user identifier sent by the advertisement monitoring tool 50.

Further, the advertisement monitoring tool 50 is further used for including an obtained user identifier in a third-party cookie under the front-end website environment in the front-end user identifier under the front-end website environment, and sending the front-end user identifier to the web site monitoring tool in the form of a custom variable; and the web site monitoring tool 60 is further used for receiving and storing the custom variable to obtain the front-end user identifier. The advertisement monitoring tool sets a monitoring code in an advertisement material in the front-end advertisement environment, for example, adding a custom variable in an exposure code and a click code to obtain additional advertisement information, wherein the additional advertisement information includes the user identifier in the third-party cookie under the front-end advertisement environment. The advertisement monitoring tool modifies the codes to store the custom variable sent by the website monitoring tool (the advertisement monitoring tool stores the additional advertisement information obtained by itself).

Besides, the advertisement monitoring tool 50 is further used for including a received user device number or advertisement identifier of the mobile terminal sent by a media application program of a mobile terminal in the front-end user identifier; and/or, the website monitoring tool 60 is further used for including a received user device number or advertisement identifier of the mobile terminal sent by a media application program of a mobile terminal in the back-end user identifier. Traditionally, the front-end advertisement monitoring tool and the back-end web site monitoring tool are two independent monitoring systems, which respectively monitor a front-end advertisement behavior and a back-end user behavior. The two monitoring systems both run on the server corresponding to the back end, and have different ways for identification of network users. The advertisement monitoring tool identifies the user through the user identifier in the third-party cookie, and the website monitoring tool identifies the user through the user identifier in the first-party cookie. The user identifiers in the two types of cookies are completely different marks, and it is usually impossible to relate the user identifiers in the two types of cookies marked as the same user, so the identity information of the advertisement user cannot be accurately identified.

In the method of this embodiment, the advertisement monitoring tool and the website monitoring tool store the user identifiers in the cookies in the form of custom variables, respectively, and the website monitoring tool transmits the user identifier in the first-party cookie to the advertisement monitoring tool in the form of a custom variable, so that the advertisement monitoring tool not only retains the original user identifier in the third-party cookie, but also stores the user identifier in the first-party cookie sent by the web site monitoring tool, thus relating multiple of identity information of the same user.

Further, the advertisement monitoring tool 50 is further used for acquiring and storing a user device number or advertisement identifier sent by a media application program in the form of a custom variable, so as to include the front-end user identifier; and the website monitoring tool is further used for acquiring and storing a user device number or advertisement identifier sent by a media application program in the form of a custom variable, so as to include the back-end user identifier. This embodiment can relate an advertisement identifier (IDFA, ADID) or user device number (MEI) of a user of a mobile terminal to a user identifier in a first-party cookie in an APP/WAP environment, and realize related identification of the identity information of the same user.

Besides, as shown in FIG. 10, the third-party tool comprises a landing page monitoring tool 70; the advertisement monitoring tool 50 is further used for sending the front-end user identifier to the landing page monitoring tool in the form of a custom variable when the user is under the front-end advertisement environment; the landing page monitoring tool 70 is used for adding the custom variable behind an advertisement landing page address in underlying data to store the front-end user identifier; the website monitoring tool 60 is further used for sending the back-end user identifier to the landing page monitoring tool in the form of a custom variable after the front-end advertisement environment jumps to the back-end website environment; and the landing page monitoring tool 70 is further used for storing the back-end user identifier in the custom variable.

Further, the landing page monitoring tool 70 is further used for conducting multi-identification on the user according to the front-end user identifier and the back-end user identifier, so as to determine the identity information of the user.

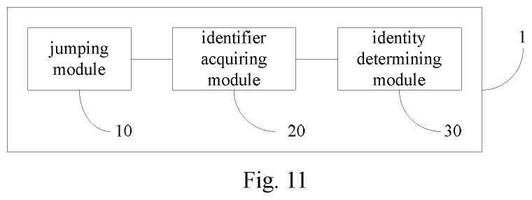

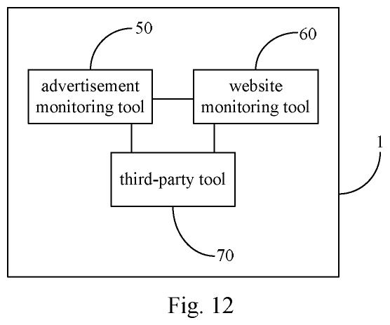

As shown in FIGS. 11 and 12, this embodiment provides a server 1 comprising the network user identification device described above. The server can determine the identity information of the same user on the same device, so as to provide better advertising service for users.

The above description is only the preferred embodiments of the present application and is not intended to limit the present application. Any modifications, equivalent replacements, improvements, etc. made within the spirit and principles of the present application shall be included in the scope of protection of the present application. In addition, within the scope of the present application, the above-mentioned technical features and/or technical schemes can be replaced, split and/or combined with each other, all of which belong to the technical contents disclosed in the present application.

1. A network user identification method, comprising:
jumping from a front-end advertisement environment to a back-end website environment when a user clicks an advertisement link under a front-end advertisement environment;
acquiring a front-end user identifier under the front-end advertisement environment and a back-end user identifier under the back-end web site environment; and
determining the identity information of the user based on the front-end user identifier and the back-end user identifier through data interaction between the front-end advertisement environment and the back-end web site environment,
wherein before the step of determining the identity information of the user based on the front-end user identifier and the back-end user identifier through data interaction between the front-end advertisement environment and the back-end website environment, said method further comprising:
when the user is under the front-end advertisement environment, sending, by the advertisement monitoring tool, the front-end user identifier to a landing page monitoring tool in the form of a custom variable;
adding, by the landing page monitoring tool, the custom variable behind an advertisement landing page address in underlying data to store the front-end user identifier;
after the front-end advertisement environment jumps to the back-end website environment, sending, by the website monitoring tool, the back-end user identifier to the landing page monitoring tool in the form of a custom variable; and
storing, by the landing page monitoring tool, the back-end user identifier in the custom variable.

2. The identification method according to claim 1, wherein the step of acquiring a front-end user identifier under the front-end advertisement environment and a back-end user identifier under the back-end website environment comprises:
including, by an advertisement monitoring tool, an obtained user identifier in a third-party cookie under the front-end advertisement environment in the front-end user identifier under the front-end advertisement environment; and
receiving, by the advertisement monitoring tool, the back-end user identifier sent by a website monitoring tool, wherein the website monitoring tool includes a user identifier in a first-party cookie under the back-end website environment in the back-end user identifier;
wherein the step of receiving, by the advertisement monitoring tool, the back-end user identifier sent by a web site monitoring tool comprises:
including, by the web site monitoring tool, the obtained user identifier in the first-party cookie under the back-end website environment in the back-end user identifier under the back-end website environment;
sending, by the web site monitoring tool, the back-end user identifier to the advertisement monitoring tool in the form of a custom variable; and
receiving and storing, by the advertisement monitoring tool, the custom variable to obtain the back-end user identifier.

3. The identification method according to claim 1, wherein the step of acquiring a front-end user identifier under the front-end advertisement environment and a back-end user identifier under the back-end website environment comprises:
including, by a website monitoring tool, an obtained user identifier in a first-party cookie under the back-end web site environment in the back-end user identifier under the back-end web site environment; and
receiving, by the web site monitoring tool, the front-end user identifier sent by an advertisement monitoring tool, wherein the advertisement monitoring tool includes a user identifier in a third-party cookie in the front-end website environment in the front-end user identifier under the front-end advertisement environment;
wherein the step of receiving, by the website monitoring tool, the front-end user identifier sent by an advertisement monitoring tool comprises:
including, by the advertisement monitoring tool, the obtained user identifier in the third-party cookie under the front-end web site environment in the front-end user identifier under the front-end web site environment;
sending, by the advertisement monitoring tool, the front-end user identifier to the website monitoring tool in the form of a custom variable; and
receiving and storing, by the website monitoring tool, the custom variable to obtain the front-end user identifier.

4. The identification method according to claim 1, wherein the step of acquiring a front-end user identifier under the front-end advertisement environment and a back-end user identifier under the back-end website environment comprises:
including, by an advertisement monitoring tool, a received user device number or advertisement identifier of the mobile terminal sent by a media application program of a mobile terminal in the front-end user identifier; and/or,
including, by a website monitoring tool, a received user device number or advertisement identifier of the mobile terminal sent by a media application program of a mobile terminal in the back-end user identifier.

5. The identification method according to claim 1, wherein the step of acquiring a front-end user identifier under the front-end advertisement environment and a back-end user identifier under the back-end website environment comprises:
obtaining, by a media application program, a user device number or advertisement identifier of the mobile terminal, and transmitting the user device number or advertisement identifier to a landing page monitoring tool in the form of a custom variable;
adding, by a landing page monitoring tool, the custom variable behind an advertisement landing page address in underlying data to store the user device number or advertisement identifier; and
after the front-end advertisement environment jumps to the back-end website environment, acquiring, by the advertisement monitoring tool, the custom variable to include the user device number or advertisement identifier in the front-end user identifier, and acquiring, by the website monitoring tool, the custom variable to include the user device number or advertisement identifier in the back-end user identifier.

6. The identification method according to claim 1, wherein the advertisement link comprises a user identifier transmitted behind a landing page address by a media application program in the form of a custom variable; and
the step of acquiring a front-end user identifier under the front-end advertisement environment and a back-end user identifier under the back-end website environment comprises: acquiring and storing, by an advertisement monitoring tool, the custom variable to acquire the front-end user identifier; and acquiring and storing, by a website monitoring tool, the custom variable to acquire the back-end user identifier;
wherein the user identifier behind a landing page address comprises a user device number or advertisement identifier.

7. The identification method according to claim 1, wherein the advertisement link comprises a user identifier transmitted behind a landing page address by a media application program in the form of a custom variable; and
the step of acquiring a front-end user identifier under the front-end advertisement environment and a back-end user identifier under the back-end website environment comprises:
storing, by a landing page monitoring tool, the user identifier behind the advertisement landing page address in underlying data as the front-end user identifier;
receiving and storing, by a web site monitoring tool, the custom variable to obtain the back-end user identifier;
sending, by the website monitoring tool, the back-end user identifier to the landing page monitoring tool in the form of a custom variable; and
adding, by the landing page monitoring tool, the custom variable behind the advertisement landing page address in the underlying data to store the back-end user identifier;
wherein the user identifier behind the landing page address comprises a user device number or advertisement identifier.

8. A network user identification device, comprising:
a jumping module, used for jumping from a front-end advertisement environment to a back-end web site environment when a user clicks an advertisement link under a front-end advertisement environment;
an identifier acquiring module, used for acquiring a front-end user identifier under the front-end advertisement environment and a back-end user identifier under the back-end website environment; and
an identity determining module, used for determining the identity information of the user based on the front-end user identifier and the back-end user identifier;
wherein the identification device further comprises an identifier concentration module, before the identity determining module determines the identity information of the user based on the front-end user identifier and the back-end user identifier through data interaction between the front-end advertisement environment and the back-end website environment, is used for:
when the user is under the front-end advertisement environment, sending, by the advertisement monitoring tool, the front-end user identifier to a landing page monitoring tool in the form of a custom variable;
adding, by the landing page monitoring tool, the custom variable behind an advertisement landing page address in underlying data to store the front-end user identifier;
after the front-end advertisement environment jumps to the back-end website environment, sending, by the website monitoring tool, the back-end user identifier to the landing page monitoring tool in the form of a custom variable; and
storing, by the landing page monitoring tool, the back-end user identifier in the custom variable.

9. The identification device according to claim 8, wherein the identifier acquiring module comprises:
a front-end user identifier acquiring module, used for including, by an advertisement monitoring tool, an obtained user identifier in a third-party cookie under the front-end advertisement environment in the front-end user identifier under the front-end advertisement environment; and
a back-end user identifier acquiring module, used for receiving, by the advertisement monitoring tool, the back-end user identifier sent by a web site monitoring tool, wherein the website monitoring tool includes a user identifier in a first-party cookie under the back-end website environment in the back-end user identifier;
wherein the back-end user identifier acquiring module is used for:
including, by the web site monitoring tool, the obtained user identifier in the first-party cookie under the back-end website environment in the back-end user identifier under the back-end website environment;
sending, by the web site monitoring tool, the back-end user identifier to the advertisement monitoring tool in the form of a custom variable; and
receiving and storing, by the advertisement monitoring tool, the custom variable to obtain the back-end user identifier.

10. The identification device according to claim 8, wherein the identifier acquiring module is used for:
including, by a website monitoring tool, an obtained user identifier in a first-party cookie under the back-end web site environment in the back-end user identifier under the back-end web site environment; and
receiving, by the web site monitoring tool, the front-end user identifier sent by an advertisement monitoring tool, wherein the advertisement monitoring tool includes a user identifier in a third-party cookie under the front-end website environment in the front-end user identifier under the front-end advertisement environment.

11. The identification device according to claim 9, wherein the identifier acquiring module is used for:
including, by the advertisement monitoring tool, the obtained user identifier in the third-party cookie under the front-end web site environment in the front-end user identifier under the front-end web site environment;
sending, by the advertisement monitoring tool, the front-end user identifier to the website monitoring tool in the form of a custom variable; and
receiving and storing, by the website monitoring tool, the custom variable to obtain the front-end user identifier.

12. The identification device according to claim 8, wherein the identifier acquiring module is further used for:
including, by an advertisement monitoring tool, a received user device number or advertisement identifier of the mobile terminal sent by a media application program of a mobile terminal in the front-end user identifier; and/or,
including, by a website monitoring tool, a received user device number or advertisement identifier of the mobile terminal sent by a media application program of a mobile terminal in the back-end user identifier.

13. The identification device according to claim 8, wherein the identifier acquiring module is used for:
obtaining, by a media application program, a user device number or advertisement identifier, and transmitting the user device number or advertisement identifier to a landing page monitoring tool in the form of a custom variable;
adding, by the landing page monitoring tool, the custom variable behind an advertisement landing page address in underlying data to store the user device number or advertisement identifier; and
after the front-end advertisement environment jumps to the back-end website environment, acquiring, by the advertisement monitoring tool, the custom variable to include the user device number or advertisement identifier in the front-end user identifier, and acquiring, by the website monitoring tool, the custom variable to include the user device number or advertisement identifier in the back-end user identifier.

14. The identification device according to claim 8, wherein the advertisement link comprises a user identifier transmitted behind a landing page address by a media application program in the form of a custom variable; and
the identifier acquiring module is used for: acquiring and storing, by an advertisement monitoring tool, the custom variable to acquire the front-end user identifier; and acquiring and storing, by a website monitoring tool, the custom variable to acquire the back-end user identifier;
wherein the user identifier behind a landing page address comprises a user device number or advertisement identifier.

15. The identification device according to claim 8, wherein the advertisement link comprises a user identifier transmitted behind a landing page address by a media application program in the form of a custom variable; and
the identifier acquiring module is used for: storing, by a landing page monitoring tool, the user identifier behind the advertisement landing page address in underlying data as the front-end user identifier;
receiving and storing, by a website monitoring tool, the custom variable to obtain the back-end user identifier;
sending, by the web site monitoring tool, the back-end user identifier to the landing page monitoring tool in the form of a custom variable; and
adding, by the landing page monitoring tool, the custom variable behind the advertisement landing page address in the underlying data to store the back-end user identifier;
wherein the user identifier behind a landing page address comprises a user device number or advertisement identifier.

16. A network user identification device, comprising:
an advertisement monitoring tool, used for acquiring a front-end user identifier under a front-end advertisement environment; and
a website monitoring tool, used for acquiring a back-end user identifier under a back-end web site environment;
wherein the advertisement monitoring tool, the web site monitoring tool, or a third-party tool is further used for determining the identity information of the user based on the front-end user identifier and the back-end user identifier through data interaction between the front-end advertisement environment and the back-end web site environment;
wherein, the identification device comprises a landing page monitoring tool, the landing page monitoring tool is used for adding the custom variable behind an advertisement landing page address in underlying data to store the front-end user identifier;
the advertisement monitoring tool is further used for sending the front-end user identifier to the landing page monitoring tool in the form of a custom variable when the user is under a front-end advertisement environment;
the website monitoring tool is further used for sending the back-end user identifier to the landing page monitoring tool in the form of a custom variable after the front-end advertisement environment jumps to a back-end website environment; and
the landing page monitoring tool is further used for storing the back-end user identifier in the custom variable.

17. The identification device according to claim 16, wherein the advertisement monitoring tool is further used for including an obtained user identifier in a third-party cookie under the front-end advertisement environment in the front-end user identifier under the front-end advertisement environment; and
the advertisement monitoring tool is further used for receiving the back-end user identifier sent by the website monitoring tool, wherein the website monitoring tool is further used for including a user identifier in a first-party cookie under the back-end web site environment in the back-end user identifier.

18. The identification device according to claim 16, wherein the website monitoring tool is further used for including an obtained user identifier in a first-party cookie under the back-end website environment in the back-end user identifier under the back-end website environment, and sending the back-end user identifier to the advertisement monitoring tool in the form of a custom variable; and
the advertisement monitoring tool is further used for receiving and storing the custom variable to obtain the back-end user identifier.

19. The identification device according to claim 16, wherein the website monitoring tool is further used for including an obtained user identifier in a first-party cookie under the back-end website environment in the back-end user identifier under the back-end website environment, and receiving the front-end user identifier sent by the advertisement monitoring tool,
wherein the advertisement monitoring tool is further used for including an obtained user identifier in a third-party cookie under the front-end website environment in the front-end user identifier under the front-end advertisement environment.

20. The identification device according to claim 16, wherein the advertisement monitoring tool is further used for including an obtained user identifier in a third-party cookie under the front-end website environment in the front-end user identifier under the front-end website environment, and sending the front-end user identifier to the web site monitoring tool in the form of a custom variable; and
the website monitoring tool is further used for receiving and storing the custom variable to obtain the front-end user identifier.

21. The identification device according to claim 16, wherein the advertisement monitoring tool is further used for including a received user device number or advertisement identifier of the mobile terminal sent by a media application program of a mobile terminal in the front-end user identifier; and/or,
the website monitoring tool is further used for including a received user device number or advertisement identifier of the mobile terminal sent by a media application program of a mobile terminal in the back-end user identifier.

22. The identification device according to claim 16, wherein the advertisement monitoring tool is further used for acquiring and storing the user device number or advertisement identifier sent by the media application program in the form of a custom variable, so as to include the front-end user identifier; and
the website monitoring tool is further used for acquiring and storing the user device number or advertisement identifier sent by the media application program in the form of a custom variable, so as to include the back-end user identifier.

23. The identification device according to claim 16, wherein
the advertisement monitoring tool is further used for acquiring and storing a custom variable to acquire the front-end user identifier; and the website monitoring tool is further used for acquiring and storing a custom variable to acquire the back-end user identifier;
wherein the custom variable comprises a user identifier transmitted behind a landing page address by a media application program in the form of a custom variable;
wherein the user identifier behind a landing page address comprises a user device number or advertisement identifier.

24. The identification device according to claim 16, wherein the website monitoring tool is further used for acquiring and storing a custom variable to acquire the back-end user identifier; the website monitoring tool is further used for sending the back-end user identifier to a landing page monitoring tool in the form of a custom variable; and
the landing page monitoring tool is further used for adding a custom variable behind an advertisement landing page address in underlying data to store the back-end user identifier;
wherein the custom variable stored in the website monitoring tool comprises a user identifier transmitted behind a landing page address by a media application program in the form of a custom variable;
wherein the user identifier behind a landing page address comprises a user device number or advertisement identifier.
